(19) United States
(12) Patent Application Publication
(10) Pub. No.: US 2026/0271115 A1
(43) Pub. Date: Sep. 10, 2026

(54) SYSTEMS AND METHODS FOR SESSION MANAGEMENT FUNCTION (SMF) RE-ALLOCATION

(71) Applicant: ZTE CORPORATION, Shenzhen, Guangdong (CN)

(72) Inventors: Menghan WANG, Shenzhen (CN); Jinguo ZHU, Shenzhen (CN); Zhijun LI, Shenzhen (CN)

(21) Appl. No.: 19/166,149

(22) PCT Filed: Mar. 23, 2023
(86) PCT No.: PCT/CN2023/083269

§ 371 Date: Sep. 17, 2025

(51) Int. Cl. H04W 76/19; H04W 48/16; H04W 48/18

(52) U.S. Cl. CPC H04W 76/19; H04W 48/16; H04W 48/18

(57) ABSTRACT

Presented are systems and methods for session management function (SMF) re-allocation. A session management function (SMF) may receive a request to establish a protocol data unit (PDU) session from an access and mobility management function (AMF). The SMF may determine that SMF re-allocation is to be performed to establish the PDU session. The SMF may send a response message indicating that the SMF re-allocation is to be performed to the AMF.

### TECHNICAL FIELD

The disclosure relates generally to wireless communications, including but not limited to systems and methods for session management function (SMF) re-allocation.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A session management function (SMF) may receive a request to establish a protocol data unit (PDU) session from an access and mobility management function (AMF). The SMF may determine that SMF re-allocation is to be performed to establish the PDU session. The SMF may send a response message indicating that the SMF re-allocation is to be performed to the AMF. SMF re-allocation may include/involve identifying/determining a target/alternative/different SMF to perform one or more operations (e.g., establishing a PDU session requested by an AMF), in place of an SMF (that may not have the capability or is not available to perform the one or more operations). SMF re-allocation may include/involve (re) allocating, (re) assigning or passing (e.g., by the SMF) the AMF's request and/or the one or more operations, to the target/alternative/different SMF. The SMF may determine, according to information in the request from the AMF, that at least one of: the SMF cannot establish the PDU session, or the SMF re-allocation is to be performed to establish the PDU session. The SMF may determine, according to information, that at least one of: the SMF does not support at least one capability required by an application triggering establishment of the PDU session, one or more UPFs managed by the SMF do not support the at least one capability, the SMF is overloaded, or the one or more UPFs are overloaded.

In some embodiments, the SMF may send an request to a network slice selection function (NSSF), to request a network repository function (NRF) to be used to select one or more network functions or services. The SMF may receive an identification of the NRF from the NSSF. The NSSF may at least one of: select a network slice instance, determine the NRF to be used to identify at least one candidate SMF within the network slice instance, or send an identifier corresponding to the network slice instance, to the SMF. The SMF may send a request to the NRF to discover the at least one candidate SMF for the PDU session. The SMF may receive information about the at least one candidate SMF from the NRF.

In some embodiments, the SMF may select a target SMF from the at least one candidate SMF. The SMF may send a request (e.g., Nsmf_PDUSession_CreateSMContext Request) to the target SMF. The request may comprise at least one of: an identifier of the AMF, an identifier of the PDU session, an N1 session management (SM) container or PDU session establishment request, a subscription permanent identifier (SUPI), a selected data network name (DNN), a DNN requested by a user equipment (UE), at least one single-network slice selection assistance information (S-NSSAI), or a request type. The SMF may receive the response message (e.g., Nsmf_PDUSession_CreateSMContext Response) from the target SMF. The response message may comprise an identifier (ID) of a session management (SM) context created by the target SMF. The SMF may send the response message (e.g., Nsmf_PDUSession_CreateSMContext Response) to the AMF. The response message may include at least one of: an ID of the target SMF, the ID of the SM context, or an indication that the target SMF is to process the request. If the AMF receives the ID of the target SMF, the AMF may communicate with the target SMF to establish the PDU session.

In some embodiments, the SMF may send the response message (e.g., Nsmf_PDUSession_CreateSMContext Response) to the AMF if the SMF is unable to identify a target SMF. The message may include at least one of: an indication that the SMF is unable to process the request, an indication that the SMF re-allocation is to be performed, or a reason that the SMF is unable to process the request. The AMF may query a network repository function (NRF) to select an alternative SMF which supports one or more capabilities (capability to establish the PDU session) that the SMF lacks.

In some embodiments, an access and mobility management function (AMF) may send a request to establish a protocol data unit (PDU) session to a session management function (SMF). The AMF may receive a response message indicating that SMF re-allocation is to be performed, if the SMF determines that the SMF re-allocation is to be performed to establish the PDU session, from the SMF.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of an example 5G system architecture, in accordance with some embodiments of the present disclosure;

FIG. 4 illustrates a sequence diagram for session management function (SMF) re-allocation, in accordance with some embodiments of the present disclosure;

FIG. 5A illustrates a sequence diagram for session management function (SMF) re-allocation, in accordance with some embodiments of the present disclosure;

FIG. 5B illustrates a sequence diagram for session management function (SMF) re-allocation, in accordance with some embodiments of the present disclosure;

FIG. 6 illustrates a sequence diagram for session management function (SMF) re-allocation, in accordance with some embodiments of the present disclosure;

FIG. 7 illustrates a sequence diagram for session management function (SMF) re-allocation, in accordance with some embodiments of the present disclosure; and

FIG. 8 illustrates a flow diagram for session management function (SMF) re-allocation, in accordance with an embodiment of the present disclosure.

### DETAILED DESCRIPTION

### 1. Mobile Communication Technology and Environment

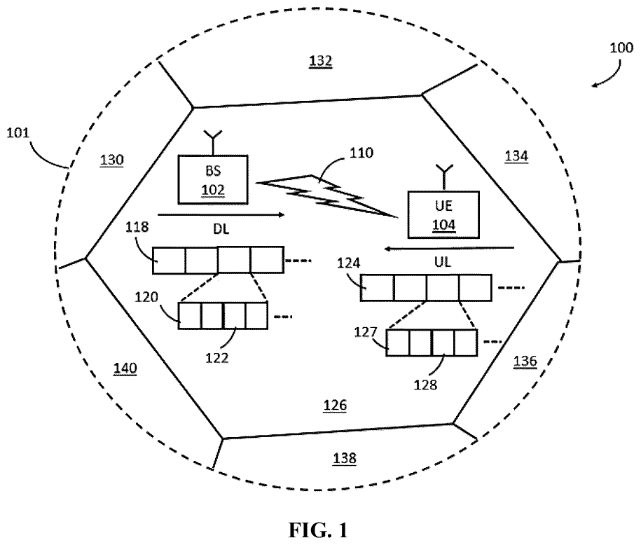

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

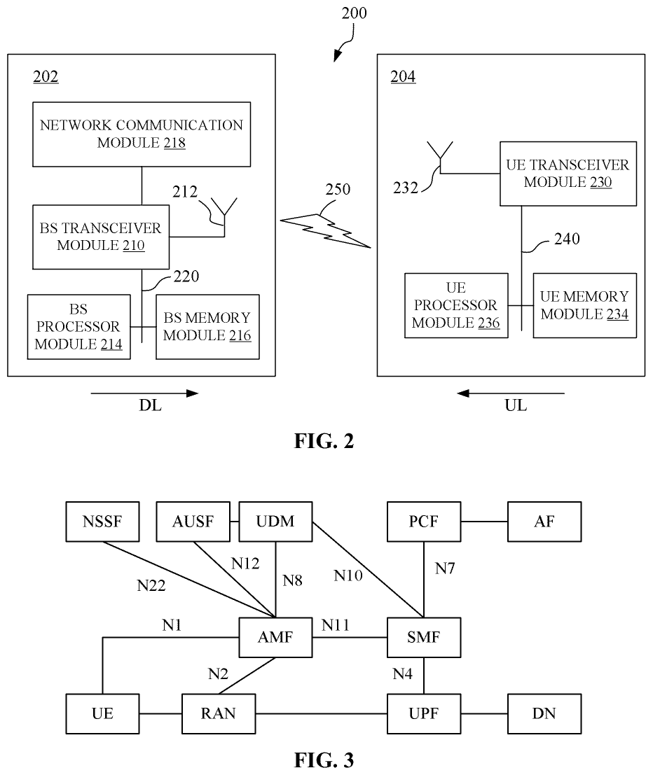

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Session Management Function (SMF) Re-Allocation

An access and mobility management function (AMF) may select a session management function (SMF) for a protocol data unit (PDU) session during a PDU session establishment procedure. However, if the selected SMF is not capable/available to handle a PDU session establishment request (e.g. the SMF may not support capabilities required by an application triggering the establishment of the PDU session, a user plane function (UPF) managed by the SMF may not support capabilities required by an application triggering the establishment of the PDU session, the SMF can be overloaded, and/or the UPF managed by the SMF can be overloaded), how to perform SMF re-allocation and which entity to perform SMF re-allocation may not be clear. A SMF re-allocation triggered by the SMF may not be supported in current or existing systems. Therefore, the present disclosure provides methods and systems to support SMF re-allocation triggered (e.g., initiated, faciliated or performed) by a SMF during a PDU session establishment procedure.

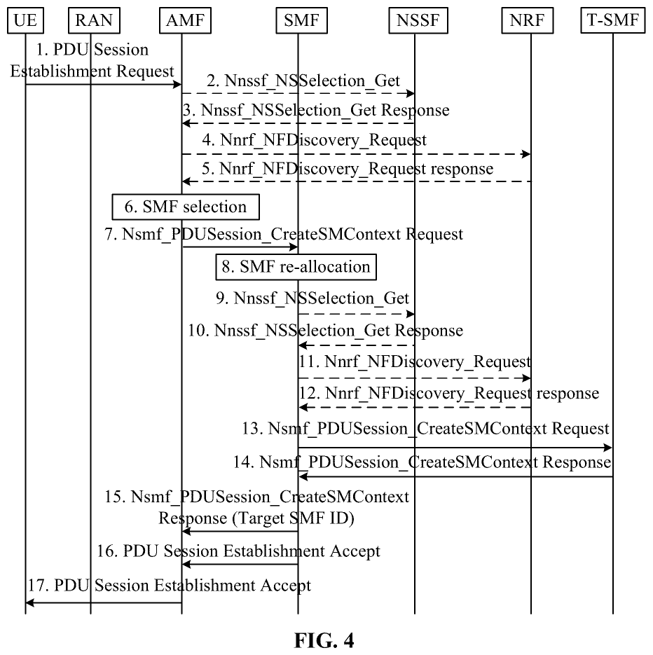

FIG. 3 illustrates a block diagram of an example 5G system (5GS) architecture, in accordance with some embodiments of the present disclosure. The 5GS architecture may include following entities and/or network functions (NFs): a user equipment (UE), a radio access network (RAN), an access and mobility management function (AMF), an unified data management (UDM), a network slice selection function (NSSF), a session management function (SMF), a user plane function (UPF), and/or a network repository function (NRF).

The AMF may include functionalities such as a UE mobility management, a reachability management, a connection management and/or a registration management. The AMF may terminate a RAN control plane (CP) interface N2 and a non-access stratum (NAS) interface N1 (e.g., NAS ciphering and integrity protection). The AMF may distribute a session management (SM) NAS to a proper SMF via a N11 interface.

The UDM may manage a subscription profile for UEs. Subscription data can be stored in a unified data repository (UDR). Subscription information may include a network slice related subscription data used for mobility management and session management. The AMF and the SMF may retrieve the subscription data from the UDM.

The NSSF may support at least one of following functionalities: selecting a set of network slice instances serving a UE; determining allowed network slice selection assistance information (NSSAI) and, if needed, a mapping to home public land mobile network (HPLMN) single NSSAIs (S-NSSAIs); determining a configured NSSAI and, if needed, a mapping to the HPLMN S-NSSAIs; or determining a AMF set to be used to serve the UE, or, based on configuration, a list of candidate AMF(s), by querying a network repository function (NRF).

The SMF may include at least one of following functionalities: a session establishment, modification and release, a UE IP address allocation and management, or a selection and control of user plane (UP) function.

The UPF may serve as an anchor point for intra-/inter-radio access technology (RAT) mobility and as an external PDU session point of interconnect to data network (DN). The UPF may also route and may forward a data packet according to an indication from the SMF. The UPF may also buffer downlink (DL) data when the UE is in idle mode.

For the sake of clarity of the point-to-point diagrams, the NRF is not depicted. However, all depicted network functions can interact with the NRF as necessary. The NRF may support a service discovery function. The NRF may receive a NF discovery request from a NF instance and may provide information of discovered NF instances to the NF instance. The NRF may maintain a NF profile of available NF instances and their supported services.

The present disclosure provides at least two different methods to support session management function (SMF) re-allocation triggered by a session management function (SMF) during a protocol data unit (PDU) session establishment procedure.

In the first method illustrated in implementation example 1 (PDU session establishment procedure in non-roaming and local break-out roaming scenario) and implementation example 2 (PDU session establishment procedure in home-routed roaming scenario), after possible interaction with a NSSF and a NRF, a SMF may determine a target SMF and may forward (e.g., send a message comprising all or a portion of) a PDU session establishment request received from an AMF, to the target SMF. The SMF may forward (e.g., send a message comprising all or a portion of) a response message received from the target SMF to the AMF, e.g., along with a target SMF ID and/or an indication that the PDU session establishment request is being processed by the target SMF. For (performing/completing) the rest of the PDU session establishment procedure, the AMF may interact with the target SMF.

In the second method illustrated in implementation example 3 (PDU session establishment procedure in non-roaming and local break-out roaming scenario) and implementation example 4 (PDU session establishment procedure in home-routed roaming scenario), after possible interaction with a NSSF and a NRF, a SMF may determine (e.g., identify, select) a target SMF and may send a target SMF ID in a response message to an AMF. If the SMF is not capable/available to select a target SMF, the SMF may include an indication in the message that the SMF is not able to process/handle/complete the PDU session establishment request, and that a SMF re-allocation can or is to be performed. In addition, the SMF may provide an indication/reason why the SMF is not able to process the PDU session establishment request in the message, so that the AMF (and/or current SMF) can re-select another SMF based on the reason why the current SMF does not support the PDU session establishment request.

### Implementation Example 1: PDU Session Establishment Procedure in Non-Roaming and Local Break-Out Roaming Scenario

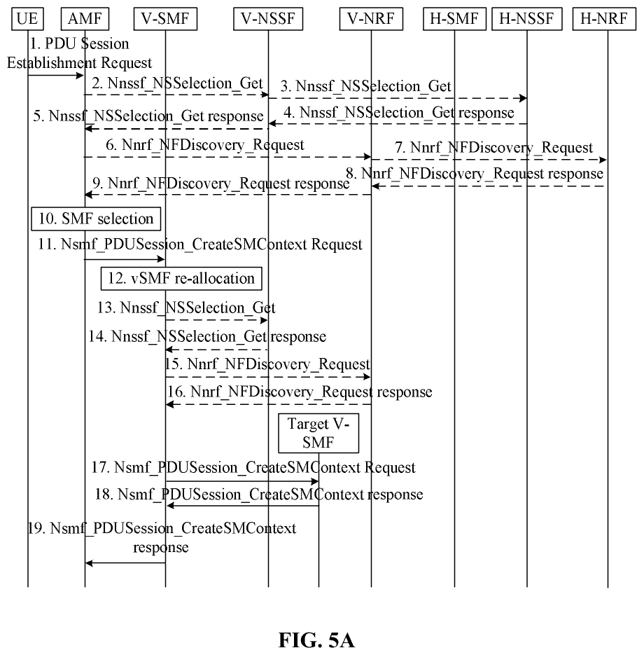

FIG. 4 illustrates a sequence diagram for session management function (SMF) re-allocation, in accordance with some embodiments of the present disclosure. After a UE registers to a network, the UE can request a PDU session establishment (e.g., establishment of a PDU session).

In step 1 (UE to AMF): A UE may initiate a UE requested PDU session establishment procedure by a transmission of a NAS message containing a PDU session establishment request within a N1 SM container. A non-access stratum (NAS) message may include at least one of: a PDU session ID, a request type, S-NSSAI(s), a UE requested data network name (DNN), or a N1 SM container (e.g., a PDU Session Establishment Request). The N1 SM container can be transparently forwarded to a network function in charge of session management (e.g., a SMF, SMF is used as example in the following procedures). If SMF information is available in an AMF by other means (e.g., locally configured), the following steps 2-5 can be skipped. If the AMF is aware of an appropriate NRF to be used to select a SMF within the corresponding network slice instance, the following steps 2 and 3 can be skipped.

In step 2 (AMF to NSSF): An AMF may invoke an Nnssf_NSSelection_Get service operation from a network slice selection function (NSSF) in a serving public land mobile network (PLMN) with an S-NSSAI of the serving PLMN from an allowed network slice selection assistance information (NSSAI) requested by the UE, a PLMN ID of the subscription permanent identifier (SUPI), a tracking area identify (TAI) of the UE, and/or an indication that the request is within a procedure of PDU session establishment in either a non-roaming or roaming with local breakout scenario.

In step 3 (NSSF to AMF): The NSSF in the serving PLMN may select a network slice instance (NSI). The NSSF may determine and may return/identify an appropriate network repository function (NRF) to be used to select NFs/services within the selected network slice instance. Optionally, the NSSF may return/provide a NSI ID corresponding to the network slice instance.

In step 4 (AMF to NRF): The AMF may query/request the appropriate NRF in the serving PLMN by issuing an Nnrf_NFDiscovery_Request. The Nnrf_NFDiscovery_Request may include at least one of: the S-NSSAI of the serving PLMN for the PDU session from the allowed NSSAI, the PLMN ID of the SUPI, the DNN, or the NSI ID if the AMF has stored an NSI ID for the S-NSSAI of the serving PLMN for the PDU session from the allowed NSSAI.

In step 5 (NRF to AMF): The NRF in the serving PLMN may provide an Nnrf_NFDiscovery_Request response message to the AMF. The Nnrf_NFDiscovery_Request response message may include a fully qualified domain name (FQDN), an IP address of a set of the discovered SMF instance(s), endpoint address(es) of SMF service instance(s), an NSI ID for the selected network slice instance corresponding to the S-NSSAI for subsequent NRF queries, load conditions of candidate SMFs, and/or a service area of candidate SMFs.

In step 6 (SMF selection): The AMF may select an SMF for the PDU session based on the received information from the NRF.

In step 7 (AMF to SMF): The AMF may forward/send a PDU session establishment request message to the selected SMF, e.g., to request establishment of a PDU session (e.g., between a UE and a server). The PDU session establishment request message (e.g., Nsmf_PDUSession_CreateSMContext Request) may include a subscription permanent identifier (SUPI), a selected DNN, a UE requested DNN, S-NSSAI(s), a PDU session ID, an AMF ID, a request type, and/or a N1 SM container (e.g., a PDU Session Establishment Request).

In step 8 (SMF re-allocation): According to the received information from the AMF, the SMF may determine that the SMF cannot serve/establish the PDU session, and/or that a SMF re-allocation can or is to be performed because of certain reason(s). For example, the certain reason(s) can be/include that the SMF does not support capabilities required by the application (e.g., of the UE or server) triggering the establishment of the PDU session, the UPF(s) managed by the SMF does not support the capabilities required by the application triggering the establishment of the PDU session, the SMF is overloaded, or the UPF(s) managed by the SMF is overloaded. The SMF may decide to perform a SMF re-allocation (e.g., to identify and/or offload to a target SMF). If information about the target SMF is available (e.g., locally configured, at the AMF and/or current SMF for instance), the following step 9 to step 12 can be skipped. If the SMF is aware of an appropriate NRF to be used to select SMF within the corresponding network slice instance, the following steps 9 and 10 can be skipped.

In step 9 (SMF to NSSF): The SMF may invoke (e.g., initiate, start, trigger, request, instruct) an Nnssf_NSSelection_Get service operation from the network slice selection function (NSSF) in the serving public land mobile network (PLMN) with the S-NSSAI of the PDU session, a PLMN ID of the SUPI, a TAI of the UE, and/or an indication that the request is within a procedure of PDU session establishment in either a non-roaming scenario, or a roaming with local breakout scenario, to request an appropriate NRF to be used to select NFs (e.g., SMF)/services (e.g., SMF service).

In step 10 (NSSF to SMF): The network slice selection function (NSSF) in the serving PLMN may select the network slice instance. The NSSF may determine the appropriate NRF to be used (e.g., to communicate with or to request) to select NFs (e.g., SMF)/services (e.g., SMF service) within the selected network slice instance. The NSSF may return (e.g., send an indication of) the appropriate NRF to the SMF. Optionally, the NSSF may return (e.g., send an indication of) a NSI ID (e.g., an identifier of an NSI) corresponding to the network slice instance to the SMF.

In step 11 (SMF to NRF): The SMF may query/request the appropriate NRF in the serving PLMN by issuing/sending an Nnrf_NFDiscovery_Request to request discovery (e.g., search, evaluation, identification) of the appropriate SMF for the PDU session. The Nnrf_NFDiscovery_Request may include at least one of: the S-NSSAI of the serving PLMN for the PDU session, a PLMN ID of the SUPI, a DNN, or a NSI ID.

In step 12 (NRF to SMF): The NRF in the serving PLMN may provide/send an Nnrf_NFDiscovery_Request response message to the SMF. The Nnrf_NFDiscovery_Request response message may include at least one of: a fully qualified domain name (FQDN), an IP address of a set of the discovered SMF instance(s), endpoint address(es) of SMF service instance(s), an NSI ID for the selected network slice instance corresponding to the S-NSSAI for subsequent NRF queries, load conditions of the candidate SMFs, or a service area of the candidate SMFs.

In step 13 (SMF to target SMF): The SMF may identify/determine/select a target SMF (e.g., from the candidate SMFs, or which is predetermined and locally recorded) and may forward the PDU session establishment request message received from the AMF to the target SMF. The SMF may send Nsmf_PDUSession_CreateSMContext Request to the target SMF. The Nsmf_PDUSession_CreateSMContext Request may include at least one of: an AMF ID, a PDU session ID, a N1 SM container (e.g., PDU Session Establishment Request), a subscription permanent identifier (SUPI), a selected DNN, a UE requested DNN, S-NSSAI(s), or a request type. In some embodiments, the SMF may send one request message to the target SMF. The request message may include (all or a part of) the message received from the AMF. In some embodiments, the request message is different in some way or form from the message received from the AMF, or may be the same as the message received from the AMF.

In step 14 (target SMF to SMF): The target SMF may send an Nsmf_PDUSession_CreateSMContext Response (e.g., SM Context ID) to the SMF. If the target SMF is able to process (e.g., support or attend to) the PDU Session establishment request, the target SMF may create an SM context and may respond to the SMF by providing an SM Context ID (e.g., identifier of the SM context). The target SMF may store the AMF ID and/or the PDU session ID associated with the PDU session.

In step 15 (SMF to AMF): The SMF may send an Nsmf_PDUSession_CreateSMContext Response message (e.g., received from the target SMF, or generated by the SMF) to the AMF. The Nsmf_PDUSession_CreateSMContext Response message may include at least one of: the SM Context ID received from the target SMF, a target SMF ID to indicate that the PDU session establishment request is being processed by the target SMF, or an indication that the PDU session establishment request is being processed by target SMF. The AMF may store the target SMF ID and/or the SM Context ID associated with the PDU session.

In step 16 (target SMF to AMF): The target SMF may send a Namf_Communication_NIN2MessageTransfer to the AMF. The Namf_Communication_N1N2MessageTransfer may include at least one of: a PDU Session ID, N2 SM information (e.g., a PDU session ID, quality of service (QoS) flow identifier(s) (QFI(s)), QoS profile(s), core network (CN) tunnel information, a S-NSSAI from the allowed NSSAI, a session-aggregate maximum bit rate (AMBR), or a PDU Session Type), or a N1 SM container (e.g., PDU session establishment accept message/indication (e.g., a selected SSC mode, S-NSSAI(s), a UE requested DNN, an allocated IPv4 address, an interface identifier, a session-AMBR, a selected PDU session type)). If the target SMF successfully establishes the PDU session, the target SMF may provide N2 SM information which carries information that the AMF can forward/send to the RAN, and a N1 SM container which contains/includes the PDU session establishment accept message/indication that the AMF can provide to the UE.

In step 17 (AMF to UE): The AMF may send a PDU session establishment accept message to the UE.

### Implementation Example 2: PDU Session Establishment Procedure in Home-Routed Roaming Scenario

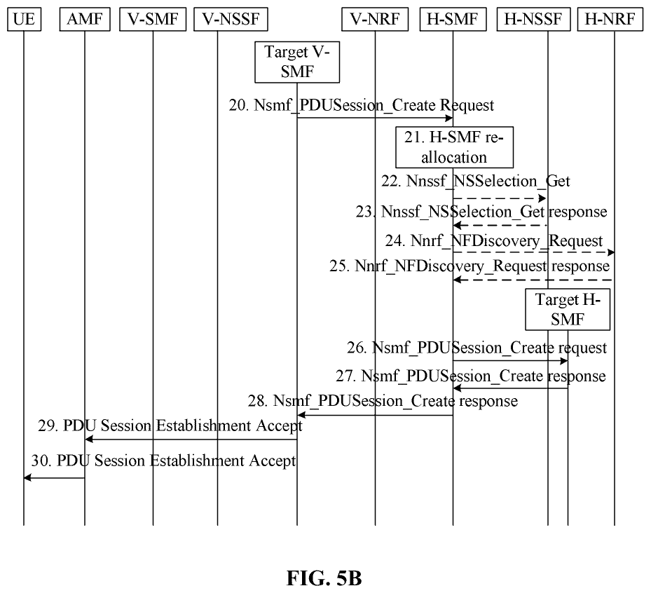

FIG. 5A illustrates a sequence diagram for session management function (SMF) re-allocation, in accordance with some embodiments of the present disclosure. FIG. 5B illustrates a sequence diagram for session management function (SMF) re-allocation, in accordance with some embodiments of the present disclosure. After a UE registers to a network, the UE can request a PDU session establishment.

In step 1 (UE to AMF): A UE may initiate a UE requested PDU session establishment procedure by a transmission of a NAS message containing a PDU session establishment request within a N1 SM container. A non-access stratum (NAS) message may include a PDU session ID, a request type, S-NSSAI(s), a UE requested data network name (DNN), and a N1 SM container (e.g., a PDU Session Establishment Request). The N1 SM container can be transparently forwarded to a network function in charge of session management (e.g., a SMF, SMF is used as example in the following procedures). The selection of the SMF in a visitor public land mobile network (VPLMN) can be performed in the same way as for non-roaming scenario, or roaming with local breakout scenario, as described in step 1 to step 6 of implementation example 1. If the home public land mobile network (HPLMN) SMF information is available in the AMF by other means (e.g., locally configured), the following steps 2-9 can be skipped. If the AMF is aware of an appropriate NRF to be used to select a HPLMN SMF, the following steps 2-5 can be skipped.

In step 2 (AMF to visitor NSSF (vNSSF)): The AMF may invoke an Nnssf_NSSelection_Get service operation from a network slice selection function (NSSF) in a visitor public land mobile network (VPLMN) with the VPLMN single-network slice selection assistance information (S-NSSAI) from allowed NSSAI requested by the UE for the PDU session, HPLMN S-NSSAI that maps to the VPLMN S-NSSAI, a PLMN ID of the subscription permanent identifier (SUPI), a tracking area identifier (TAI) of the UE, and/or an indication that the request is within a procedure of PDU session establishment in the home-routed roaming scenario.

In step 3 (vNSSF to home NSSF (hNSSF)): If slicing configuration information for the S-NSSAI in a home public land mobile network (HPLMN) is not available (e.g., the vNSSF has no cached information), the NSSF of the VPLMN may invoke a Nnssf_NSSelection_Get service operation from NSSF of the HPLMN according to the PLMN ID of subscription permanent identifier (SUPI) by including the HPLMN S-NSSAI.

In step 4 (hNSSF to vNSSF): The NSSF in HPLMN may include a NSI ID, if needed, for a network slice instance in the HPLMN selected for the corresponding S-NSSAI of the HPLMN in the Nnssf_NSSelection_Get response. The NSSF in the HPLMN may also include an appropriate hNRF to be used to select NFs/services within the HPLMN in the Nnssf_NSSelection_Get response.

In step 5 (vNSSF to AMF): The serving NSSF may include in the Nnssf_NSSelection_Get response all/some of the information that has been received from the NSSF in the HPLMN when responding to the AMF.

In step 6 (AMF to visitor NRF (vNRF)): The AMF may query (e.g., send a request to) a target vNRF using an Nnrf_NFDiscovery_Request. The Nnrf_NFDiscovery_Request may include a PLMN ID of the SUPI, a DNN, a HPLMN S-NSSAI, a hNRF, and/or an HPLMN NSI ID for the selected network slice instance corresponding to the HPLMN S-NSSAI if available in the AMF (e.g., obtained from the HPLMN NSSF in steps 4 and 5 or cached from a previous H-NSSF query).

In step 7 (vNRF to home NRF (hNRF)): The NRF in serving PLMN may identify a NRF in HPLMN (hNRF) based on the information provided by the NSSF in the serving PLMN. The vNRF may invoke a Nnrf_NFDiscovery_Request service from the hNRF to get expected SMF instance(s) deployed in the HPLMN. As the vNRF in VPLMN triggers the “NF Discovery” on behalf of the AMF, the NRF in the VPLMN may not replace the information of the NF (e.g., AMF ID) in the Nnrf_NFDiscovery_Request message. The vNRF may send the Nnrf_NFDiscovery_Request message to the hNRF.

In steps 8-9: The hNRF may provide/send to the AMF, via vNRF, the information. The information may include at least one of: a FQDN or a IP address, of a set of the SMF instance(s) in Nnrf_NFDiscovery_Request response message, an NSI ID for the selected network slice instance corresponding to the S-NSSAI of the HPLMN for subsequent NRF queries, load conditions of the candidate SMFs, or a service area of the candidate SMFs.

In step 10 (SMF selection): The AMF may select/identify an VPLMN SMF and/or an HPLMN SMF for the PDU session based on the received information from the NRF.

In step 11 (AMF to vSMF): Similar to step 7 of implementation example 1, with the addition that the AMF may provide an identity of the H-SMF it has selected, and both the VPLMN S-NSSAI from the allowed NSSAI and the corresponding S-NSSAI of the HPLMN, which can be in the mapping the VPLMN S-NSSAI from the allowed NSSAI. The AMF may also provide an identity of alternative H-SMFs if the AMF has received the identity from the NRF.

In step 12 (vSMF re-allocation): According to the received information from the AMF, the vSMF may determine that the vSMF cannot serve the PDU session, and that a vSMF re-allocation may be performed because of certain reasons. For example, the certain reasons may include: the vSMF does not support the capabilities required by the application triggering the establishment of the PDU session, the UPF(s) managed by the vSMF does not support the capabilities required by application triggering the establishment of the PDU session, the vSMF is overloaded, or the UPF(s) managed by the vSMF is overloaded. The vSMF may decide to perform a vSMF re-allocation. If the target vSMF information is available (e.g., locally configured), the following step 13 to step 16 can be skipped. If the vSMF is aware of an appropriate vNRF to be used to select vSMF within the corresponding network slice instance, the following step 13 and 14 can be skipped.

In step 13 (vSMF to vNSSF): The vSMF may invoke a Nnssf_NSSelection_Get service operation from the NSSF in the serving PLMN with the VPLMN S-NSSAI of the PDU session, a PLMN ID of the SUPI, a TAI of the UE, and/or an indication that the request is within a procedure of PDU Session establishment in the home-routed roaming scenario, to request appropriate vNRF to be used to select NFs (e.g., vSMF)/services (e.g., vSMF service).

In step 14 (vNSSF to vSMF): The NSSF in the serving PLMN may select/identify/determine the network slice instance. The NSSF may determine the appropriate NRF to be used to select NFs (e.g., SMF)/services (e.g., SMF service) within the selected network slice instance. The vNSSF may return (e.g., send an indication/message of) the appropriate NRF to the vSMF. Optionally, the vNSSF may return a NSI ID corresponding to the network slice instance to the vSMF.

In step 15 (vSMF to vNRF): The vSMF may query/request the appropriate NRF in serving PLMN by issuing the Nnrf_NFDiscovery_Request to request discovery of the appropriate vSMF for the PDU session. The Nnrf_NFDiscovery_Request may include at least one of: the S-NSSAI of the serving PLMN for the PDU session, a PLMN ID of the SUPI, a DNN, or a NSI ID.

In step 16 (vNRF to vSMF): The vNRF in the serving PLMN may provide/send an Nnrf_NFDiscovery_Request response message to the vSMF. The Nnrf_NFDiscovery_Request response message may include at least one of: a fully qualified domain name (FQDN), an IP address of a set of the discovered SMF instance(s), endpoint address(es) of SMF service instance(s), an NSI ID for the selected network slice instance corresponding to the S-NSSAI for subsequent NRF queries, load conditions of the candidate SMFs, or a service area of the candidate SMFs.

In step 17 (vSMF to target vSMF): The vSMF may select a target vSMF and may forward (e.g., send a message comprising at least a portion of contents of) the PDU session establishment request message received from the AMF, to the target vSMF. The vSMF may send Nsmf_PDUSession_CreateSMContext Request to the target vSMF. The Nsmf_PDUSession_CreateSMContext Request may include at least one of: an AMF ID, a PDU session ID, a HPLMN SMF ID, a VPLMN S-NSSAI and corresponding HPLMN S-NSSAI, a N1 SM container (e.g., PDU Session Establishment Request), a SUPI, a selected DNN, a UE requested DNN, or a request type.

In step 18 (target vSMF to vSMF): The target SMF may send an Nsmf_PDUSession_CreateSMContext Response (e.g., SM Context ID) to the vSMF. If the target vSMF is able to process the PDU Session establishment request, the target vSMF may create an SM context and may respond to the vSMF by providing an SM Context ID. The target vSMF may store the AMF ID, the PDU session ID, and/or the HPLMN SMF ID associated with the PDU session.

In step 19 (vSMF to AMF): The vSMF may send an Nsmf_PDUSession_CreateSMContext Response message to the AMF. The Nsmf_PDUSession_CreateSMContext Response message may include at least one of: the SM Context ID received from the target vSMF, a target vSMF ID to indicate that the PDU session establishment request is being processed by target vSMF, or an indication that the PDU session establishment request is being processed by the target SMF. The AMF may store the target VSMF ID and/or the SM Context ID associated with the PDU session.

In step 20 (target vSMF to home SMF (hSMF)): The target vSMF may send an Nsmf_PDUSession_Create Request to a hSMF. The Nsmf_PDUSession_Create Request may include a SUPI, a V-SMF SM context ID, a DNN, S-NSSAI with a value defined by the HPLMN, a PDU Session ID, a target V-SMF ID, V-CN-tunnel-information, a PDU session type, a protocol configuration option (PCO), user location information, an access type, or a radio access technology (RAT) type.

In step 21 (hSMF re-allocation): According to the received information from the vSMF, the hSMF may determine that the hSMF cannot serve the PDU session and hSMF re-allocation can be performed because of certain reasons. For example, the certain reasons can be: the hSMF does not support the capabilities required by the application triggering the establishment of the PDU session, the UPF(s) managed by the hSMF does not support the capabilities required by application triggering the establishment of the PDU session, the hSMF is overloaded, and/or the UPF(s) managed by the hSMF is overloaded. The hSMF may decide to perform an hSMF re-allocation. If the target hSMF information is available (e.g., locally configured), the following step 22 to step 25 can be skipped. If the hSMF is aware of an appropriate hNRF to be used to select hSMF within the corresponding network slice instance, the following step 22 and 23 can be skipped.

In step 22 (hSMF to hNSSF): The hSMF may invoke a Nnssf_NSSelection_Get service operation from the NSSF in the HPLMN with the HPLMN S-NSSAI of the PDU session, a PLMN ID of the SUPI, a TAI of the UE, and/or an indication that the request is within a procedure of PDU session establishment in the home-routed roaming scenario, to request appropriate hNRF to be used to select NFs (e.g., hSMF)/services (e.g., hSMF service).

In step 23 (hNSSF to hSMF): The NSSF in HPLMN may select the network slice instance. The NSSF may determine the appropriate hNRF to be used to select NFs (e.g., SMF)/services (e.g., SMF service) within the selected Network Slice instance. The hNSSF may return the appropriate hNRF to the hSMF. Optionally, the hNSSF may return a NSI ID corresponding to the network slice instance to the hSMF.

In step 24 (hSMF to hNRF): The hSMF may query/request the appropriate NRF in the HPLMN by issuing/sending the Nnrf_NFDiscovery_Request to request discovery of the appropriate hSMF for the PDU session. The Nnrf_NFDiscovery_Request may include at least one of: the S-NSSAI of the HPLMN for this PDU session, a PLMN ID of the SUPI, a DNN, or a NSI ID.

In step 25 (hNRF to hSMF): The NRF in hPLMN may provide/send to the SMF in an Nnrf_NFDiscovery_Request response message. The Nnrf_NFDiscovery_Request response message may include at least one of: a FQDN, an IP address of a set of the discovered SMF instance(s), endpoint address(es) of SMF service instance(s), an NSI ID for the selected network slice instance corresponding to the S-NSSAI for subsequent NRF queries, load conditions of the candidate SMFs, or a service area of the candidate SMFs.

In step 26 (hSMF to target hSMF): The hSMF may select a target hSMF and may forward/send the PDU session establishment request message received from the vSMF to a target hSMF. The hSMF may send an Nsmf_PDUSession_Create Request to the target hSMF. The Nsmf_PDUSession_Create Request may include at least one of: a SUPI, a V-SMF SM Context ID, a DNN, S-NSSAI with the value defined by the HPLMN, a PDU session ID, a target V-SMF ID, V-CN-Tunnel-Information, a PDU session type, a PCO, user location information, an access type, or a RAT type.

In step 27 (target hSMF to hSMF): The target hSMF may send an Nsmf_PDUSession_Create Response to the hSMF. The target hSMF may store a V-SMF ID and/or a V-SMF SM Context ID associated with the PDU session.

In step 28 (hSMF to target vSMF): The hSMF may forward/send (e.g., a message comprising at least a portion of) the Nsmf_PDUSession_Create Response message received from the target hSMF to the target vSMF. The Nsmf_PDUSession_Create Response message may include a target hSMF ID indicating that the PDU session is established by the target hSMF. The vSMF may store the target hSMF ID associated with the PDU session.

In step 29 (target vSMF to AMF): This step can be similar to step 16 of implementation example 1.

In step 30 (AMF to UE): The AMF may send a PDU session establishment accept message to the UE.

### Implementation Example 3: PDU Session Establishment Procedure in Non-Roaming and Local Break-Out Roaming Scenario

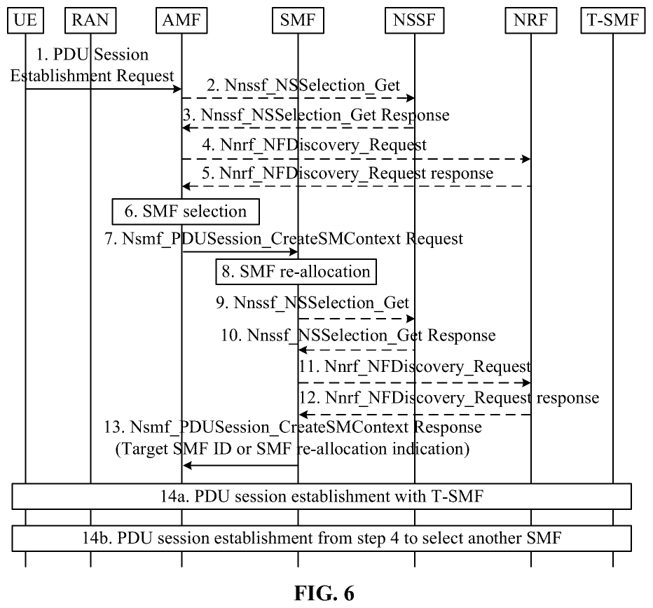

FIG. 6 illustrates a sequence diagram for session management function (SMF) re-allocation, in accordance with some embodiments of the present disclosure. After a UE registers to a network, the UE can request a PDU session establishment.

In step 1 (UE to AMF): A UE may initiate a UE requested PDU session establishment procedure, by a transmission of a NAS message containing a PDU session establishment request within a N1 SM container. The NAS message may include at least one of: a PDU Session ID, a request type, S-NSSAI(s), a UE requested DNN, or a N1 SM container (e.g., PDU Session Establishment Request). The N1 SM container can be transparently forwarded to a network function in charge of session management (e.g., a SMF, SMF is used as example in the following procedures). If SMF information is available in the AMF by other means (e.g., locally configured), the following steps 2-5 can be skipped. If the AMF is aware of an appropriate NRF to be used to select a SMF within the corresponding network slice instance, the following steps 2 and 3 can be skipped.

In step 2 (AMF to NSSF): An AMF may invoke/initiate an Nnssf_NSSelection_Get service operation from a NSSF in the serving PLMN with an S-NSSAI of the serving PLMN from an allowed NSSAI requested by the UE, a PLMN ID of the SUPI, a TAI of the UE, and/or an indication that the request is within a procedure of PDU Session establishment in either the non-roaming or roaming with local breakout scenario.

In step 3 (NSSF to AMF): The NSSF in serving PLMN may select/identify a network slice instance (NSI). The NSSF may determine and may return/identify the appropriate NRF to be used to select NFs/services within the selected network slice instance. Optionally, the NSSF may return a NSI ID corresponding to the network slice instance.

In step 4 (AMF to NRF): The AMF may query/request the appropriate NRF in serving PLMN by issuing the Nnrf_NFDiscovery_Request. The Nnrf_NFDiscovery_Request may include at least one of: the S-NSSAI of the serving PLMN for the PDU session from the allowed NSSAI, the PLMN ID of the SUPI, the DNN, or the NSI ID if the AMF has stored an NSI ID for the S-NSSAI of the serving PLMN for the PDU session from the allowed NSSAI.

In step 5 (NRF to AMF): The NRF in serving PLMN may provide an Nnrf_NFDiscovery_Request response message to the AMF. The Nnrf_NFDiscovery_Request response message may include a FQDN, an IP address of a set of the discovered SMF instance(s), endpoint Address(es) of SMF service instance(s), an NSI ID for the selected network slice instance corresponding to the S-NSSAI for subsequent NRF queries, load conditions of the candidate SMFs, and/or a service area of the candidate SMFs.

In step 6 (SMF selection): The AMF may select/determine an SMF for the PDU session based on the received information from NRF.

In step 7 (AMF to SMF): The AMF may forward the PDU session establishment request message to the selected SMF. The PDU session establishment request message (e.g., Nsmf_PDUSession_CreateSMContext Request) may include at least one of: a SUPI, a selected DNN, a UE requested DNN, S-NSSAI(s), a PDU Session ID, an AMF ID, a request type, an N1 SM container (e.g., PDU Session Establishment Request).

In step 8 (SMF re-allocation): According to the received information from AMF, the SMF may determine that the SMF cannot serve/establish the PDU session, and that a SMF re-allocation can or is to be performed because of certain reasons. For example, the certain reason can be that the SMF does not support capabilities required by the application triggering the establishment of the PDU session, the UPF(s) managed by the SMF does not support the capabilities required by application triggering the establishment of the PDU session, the SMF is overloaded, or the UPF(s) managed by the SMF is overloaded. The SMF may decide to perform a SMF re-allocation. If the target SMF information is available (e.g., locally configured), the following step 9 to step 12 can be skipped. If the SMF is aware of an appropriate NRF to be used to select SMF (e.g., a target SMF) within the corresponding network slice instance, the following steps 9 and 10 can be skipped.

In step 9 (SMF to NSSF): The SMF may invoke the Nnssf_NSSelection_Get service operation from the NSSF in the serving PLMN with the S-NSSAI of the PDU session, a PLMN ID of the SUPI, a TAI of the UE, and/or an indication that the request is within a procedure of PDU session establishment in either the non-roaming or roaming with local breakout scenario, to request appropriate NRF to be used to select NFs (e.g., SMF)/services (e.g., SMF service).

In step 10 (NSSF to SMF): The NSSF in the serving PLMN may select the network slice instance. The NSSF may determine the appropriate NRF to be used to select NFs (e.g., SMF)/services (e.g., SMF service) within the selected network slice instance. The NSSF may send the appropriate NRF to the SMF. Optionally, the NSSF may return a NSI ID corresponding to the network slice instance.

In step 11 (SMF to NRF): The SMF can query/request the appropriate NRF in serving PLMN by issuing/sending an Nnrf_NFDiscovery_Request to request discovery of the appropriate SMF for the PDU session. The Nnrf_NFDiscovery_Request may include at least one of: the S-NSSAI of the serving PLMN for the PDU session, a PLMN ID of the SUPI, a DNN, or a NSI ID.

In step 12 (NRF to SMF): The NRF in serving PLMN may provide/send an Nnrf_NFDiscovery_Request response message to the SMF. The Nnrf_NFDiscovery_Request response message may include at least one of: a FQDN, an IP address of a set of the discovered SMF instance(s), endpoint address(es) of SMF service instance(s), an NSI ID for the selected network slice instance corresponding to the S-NSSAI for subsequent NRF queries, load conditions of the candidate SMFs, or a service area of the candidate SMFs.

In step 13 (SMF to AMF): The SMF may send a Nsmf_PDUSession_CreateSMContext Response message to the AMF. If the SMF has selected a target SMF, the SMF may include the target SMF ID in the message. If the SMF is not capable to select a target SMF, the SMF may include an indication in the message that the SMF is not able to process the PDU session establishment request and SMF re-allocation can be performed. Furthermore, the SMF may provide a reason why the SMF is not able to process the PDU session establishment request.

In step 14a: If the AMF receives the target SMF ID from the SMF, the AMF may proceed the PDU session establishment procedure with the target SMF.

In step 14b: If the AMF receives an indication and optionally the reason from SMF that the SMF is not able to process the PDU session establishment request and a SMF re-allocation can be performed, the AMF may query/request the NRF as in step 4 to select another SMF which can support the capability that the SMF is not capable of.

### Implementation Example 4: PDU Session Establishment Procedure in Home-Routed Roaming Scenario

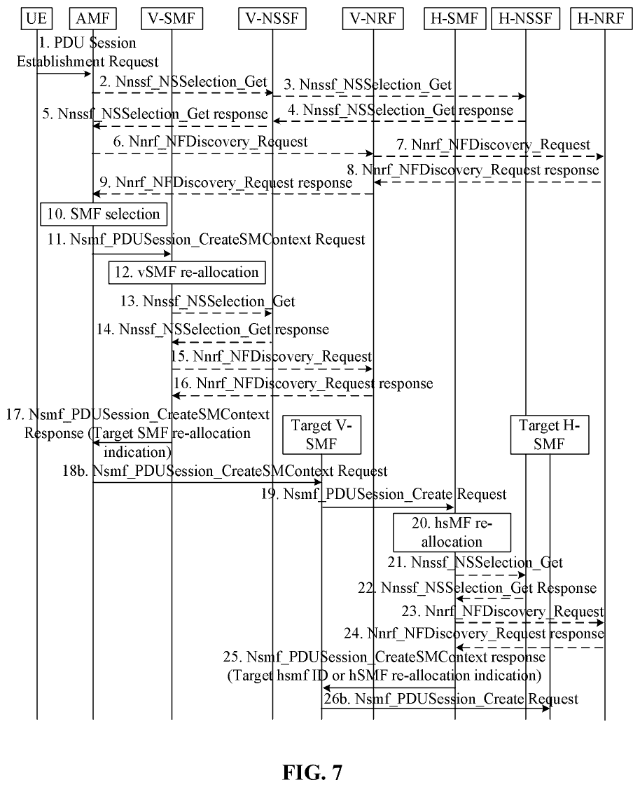

FIG. 7 illustrates a sequence diagram for session management function (SMF) re-allocation, in accordance with some embodiments of the present disclosure. After a UE registers to a network, the UE can request a PDU session establishment.

In step 1 (UE to AMF): A UE may initiate a UE requested PDU session establishment procedure by a transmission of a NAS message containing a PDU session establishment request within a N1 SM container. A non-access stratum (NAS) message may include a PDU session ID, a request type, S-NSSAI(s), a UE requested data network name (DNN), and/or a N1 SM container (e.g., a PDU Session Establishment Request). The N1 SM container can be transparently forwarded to a network function in charge of session management (e.g., a SMF, SMF is used as example in the following procedures). The selection of the SMF in a visitor public land mobile network (VPLMN) can be performed in the same way as for non-roaming and roaming with local breakout as described in step 1 to step 6 of implementation example 1. If the home public land mobile network (HPLMN) SMF information is available in the AMF by other means (e.g., locally configured), the following steps 2-9 can be skipped. If the AMF is aware of an appropriate NRF to be used to select a HPLMN SMF, the following step 2 to step 5 can be skipped.

In step 2 (AMF to vNSSF): The AMF may invoke/trigger an Nnssf_NSSelection_Get service operation from a network slice selection function (NSSF) in a VPLMN with the VPLMN S-NSSAI from the allowed NSSAI requested by the UE for the PDU Session, HPLMN S-NSSAI that maps to the VPLMN S-NSSAI, PLMN ID of the SUPI, a TAI of the UE, and/or an indication that the request is within a procedure of PDU session establishment in the home-routed roaming scenario.

In step 3 (vNSSF to hNSSF): If slicing configuration information for the S-NSSAI in a HPLMN is not available (e.g., the vNSSF has no cached information), the NSSF of the VPLMN may invoke a Nnssf_NSSelection_Get service operation from NSSF of the HPLMN according to the PLMN ID of SUPI by including the HPLMN S-NSSAI.

In step 4 (hNSSF to vNSSF): The NSSF in HPLMN may include a NSI ID, if needed, for a network slice instance in the HPLMN selected for the corresponding S-NSSAI of the HPLMN in the Nnssf_NSSelection_Get response. The NSSF in HPLMN may also include/identify or communicate with an appropriate hNRF to be used to select NFs/services within HPLMN in the Nnssf_NSSelection_Get response.

In step 5 (vNSSF to AMF): The serving NSSF may include in the Nnssf_NSSelection_Get response all/some of the information that has been received from the NSSF in HPLMN when responding to the AMF.

In step 6 (AMF to vNRF): The AMF may query/request a target vNRF using an Nnrf_NFDiscovery_Request. The Nnrf_NFDiscovery_Request may include a PLMN ID of the SUPI, a DNN, a HPLMN S-NSSAI, a hNRF, an HPLMN NSI ID for the selected network slice instance corresponding to the HPLMN S-NSSAI if available in the AMF (e.g., obtained from the HPLMN NSSF in steps 4 and 5 or cached from a previous H-NSSF query).

In step 7 (vNRF to hNRF): The NRF in serving PLMN may identify a NRF in HPLMN (hNRF) based on the information provided by the NSSF in the serving PLMN. The vNRF may invoke a Nnrf_NFDiscovery_Request service from the hNRF to get the expected SMF instance(s) deployed in the HPLMN. As the vNRF in VPLMN triggers the “NF Discovery” on behalf of the AMF, the NRF in the VPLMN may not replace the information of the NF (e.g., AMF ID) in the Nnrf_NFDiscovery_Request message. The vNRF may send the Nnrf_NFDiscovery_Request message to the hNRF.

In steps 8-9: The hNRF may provide to the AMF, via vNRF, the information. The information may include at least one of: a FQDN, a IP address, of a set of the SMF instance(s) in Nnrf_NFDiscovery_Request response message, an NSI ID for the selected network slice instance corresponding to the S-NSSAI of the HPLMN for subsequent NRF queries, load conditions of the candidate SMFs, or a service area of the candidate SMFs.

In step 10 (SMF selection): The AMF may select an VPLMN SMF and/or an HPLMN SMF for the PDU session based on the received information from the NRF.

In step 11 (AMF to vSMF): Similar to step 7 of implementation example 1, with the addition that the AMF may provide an identity of the H-SMF it has selected, and both the VPLMN S-NSSAI can be from the allowed NSSAI and the corresponding S-NSSAI of the HPLMN, which can be in the mapping of the VPLMN S-NSSAI from the allowed NSSAI. The AMF may also provide the identity of alternative H-SMFs if the AMF has received the identity from the NRF.

In step 12 (vSMF re-allocation): According to the received information from the AMF, the vSMF may determine that the vSMF cannot serve the PDU session, and that a vSMF re-allocation cannot be performed because of certain reasons. For example, the certain reasons can be that the vSMF does not support the capabilities required by the application triggering the establishment of the PDU session, the UPF(s) managed by the vSMF does not support the capabilities required by application triggering the establishment of the PDU session, the vSMF is overloaded, and/or the UPF(s) managed by the vSMF is overloaded. The vSMF may decide to perform a vSMF re-allocation. If the target vSMF information is available (e.g., locally configured), the following step 13 to step 16 can be skipped. If the vSMF is aware of an appropriate vNRF to be used to select vSMF within the corresponding network slice instance, the following steps 13 and 14 can be skipped.

In step 13 (vSMF to vNSSF): The vSMF may invoke the Nnssf_NSSelection_Get service operation from the NSSF in the serving PLMN with the VPLMN S-NSSAI of the PDU session, a PLMN ID of the SUPI, a TAI of the UE, and/or an indication that the request is within a procedure of PDU Session establishment in the home-routed roaming scenario, to request appropriate vNRF to be used to select NFs (e.g., vSMF)/services (e.g., vSMF service).

In step 14 (vNSSF to vSMF): The NSSF in the serving PLMN may select the network slice instance. The NSSF may determine the appropriate NRF to be used to select NFs (e.g., SMF)/services (e.g. SMF service) within the selected network slice instance. The vNSSF may return the appropriate NRF to the vSMF. Optionally, the vNSSF may return a NSI ID corresponding to the network slice instance.

In step 15 (vSMF to vNRF): The vSMF may query/request the appropriate NRF in the serving PLMN by issuing/sending the Nnrf_NFDiscovery_Request to request discovery of the appropriate vSMF for the PDU session. The Nnrf_NFDiscovery_Request may include at least one of: the S-NSSAI of the serving PLMN for the PDU session, a PLMN ID of the SUPI, a DNN, or a NSI ID.

In step 16 (vNRF to vSMF): The NRF in the serving PLMN may provide/send an Nnrf_NFDiscovery_Request response message to the SMF. The Nnrf_NFDiscovery_Request response message may include at least one of: a FQDN, an IP address of a set of the discovered SMF instance(s), endpoint address(es) of SMF service instance(s), an NSI ID for the selected network slice instance corresponding to the S-NSSAI for subsequent NRF queries, load conditions of the candidate SMFs, or a service area of the candidate SMFs.

In step 17 (vSMF to AMF): The vSMF may send an Nsmf_PDUSession_CreateSMContext Response message to the AMF. If the vSMF has selected a target vSMF, the vSMF may include the target vSMF ID in the message. If the vSMF is not capable to select a target vSMF, the vSMF may include an indication in the message that the vSMF is not able to process the PDU session establishment request and a SMF re-allocation can be performed. Furthermore, the vSMF may provide a reason why the vSMF is not able to process the PDU session establishment request.

In step 18a: If the AMF receives an indication and optionally the reason from vSMF that the vSMF is not able to process the PDU session establishment request. A vSMF re-allocation can be performed. The AMF may query NRF as in step 6 to select another vSMF which supports the capability that the vSMF is not capable of.

In step 18b: If the AMF receives a target vSMF ID from the vSMF, the AMF may proceed with the PDU session establishment procedure with a target vSMF as in step 11. The AMF may store the target vSMF ID.

In step 19 (target vSMF to hSMF): The target vSMF may send an Nsmf_PDUSession_Create Request message to the hSMF. The Nsmf_PDUSession_Create Request message may include at least one of: a SUPI, a V-SMF SM Context ID, a DNN, a S-NSSAI with the value defined by the HPLMN, a PDU Session ID, a target V-SMF ID, V-CN-Tunnel-Information, a PDU session type, a PCO, user location information, an access type, or a RAT type.

In step 20 (hSMF re-allocation): According to the received information from the vSMF, the hSMF may determine that the hSMF cannot establish/serve the PDU session and a hSMF re-allocation can or is to be performed because of certain reasons. For example, the certain reasons may include that the hSMF does not support the capabilities required by the application triggering the establishment of the PDU session, the UPF(s) managed by the hSMF does not support the capabilities required by application triggering the establishment of the PDU session, the hSMF is overloaded, and/or the UPF(s) managed by the hSMF is overloaded. The hSMF may decide to perform an hSMF re-allocation. If the target hSMF information is available (e.g., locally configured), the following step 21 to step 24 can be skipped. If the hSMF is aware of an appropriate hNRF to be used to select hSMF within the corresponding network slice instance, the following step 21 and 22 can be skipped.

In step 21 (hSMF to hNSSF): The hSMF may invoke/initiate a Nnssf_NSSelection_Get service operation from the NSSF in HPLMN with the HPLMN S-NSSAI of the PDU session, PLMN ID of the SUPI, the TAI of the UE, and/or the indication that the request is within a procedure of PDU session establishment in the home-routed roaming scenario, to request appropriate hNRF to be used to select NFs (e.g., hSMF)/services (e.g., hSMF service).

In step 22 (hNSSF to hSMF): The NSSF in HPLMN may select/identify the network slice instance. The hNSSF may determine the appropriate hNRF to be used to select NFs (e.g., SMF)/services (e.g., SMF service) within the selected network slice instance. The hNSSF may send an Nsmf_NSSelection Get response to the hSMF. The hNSSF may optionally return a NSI ID corresponding to the network slice instance.

In step 23 (hSMF to hNRF): The hSMF may query the appropriate NRF in the HPLMN by issuing the Nnrf_NFDiscovery_Request. The Nnrf_NFDiscovery_Request may include at least one of: the S-NSSAI of the HPLMN for the PDU Session, the PLMN ID of the SUPI, the DNN, or the NSI ID, to request discovery of the appropriate hSMF for the PDU session.

In step 24 (hNRF to hSMF): The NRF in hPLMN may provide/send to the SMF in an Nnrf_NFDiscovery_Request response message. The Nnrf_NFDiscovery_Request response message may include at least one of: a FQDN, a IP address of a set of the discovered SMF instance(s), endpoint address(es) of SMF service instance(s), an NSI ID for the selected network slice instance corresponding to the S-NSSAI for subsequent NRF queries, load conditions of the candidate SMFs, or a service area of the candidate SMFs.

In step 25 (hSMF to vSMF): The hSMF may send an Nsmf_PDUSession_Create Response message to the vSMF. If the hSMF has selected a target hSMF, the hSMF may include the target hSMF ID in the message. If the hSMF is not capable to select a target hSMF, the hSMF may include an indication in the message that the hSMF is not able to process the PDU session establishment request and a SMF re-allocation can be performed. Furthermore, the hSMF may provide the reason why the hSMF is not able to process the PDU session establishment request.

In step 26a: If the vSMF receives an indication and optionally the reason from the hSMF that the hSMF is not able to process the PDU session establishment request and a hSMF re-allocation can be performed, the vSMF may forward the information to the AMF and the AMF may query the NRF as in step 6 to select another hSMF which can support the capability that the hSMF is not capable of.

In step 26b: If the vSMF receives a target hSMF ID from the hSMF, the vSMF may proceed the PDU session establishment procedure with the target hSMF as in step 19. The vSMF may store the target hSMF ID. The vSMF may provide the target hSMF ID to the AMF. The AMF may store the target hSMF ID for the PDU session.

It should be understood that one or more features from the above implementation examples are not exclusive to the specific implementation examples, but can be combined in any manner (e.g., in any priority and/or order, concurrently or otherwise).

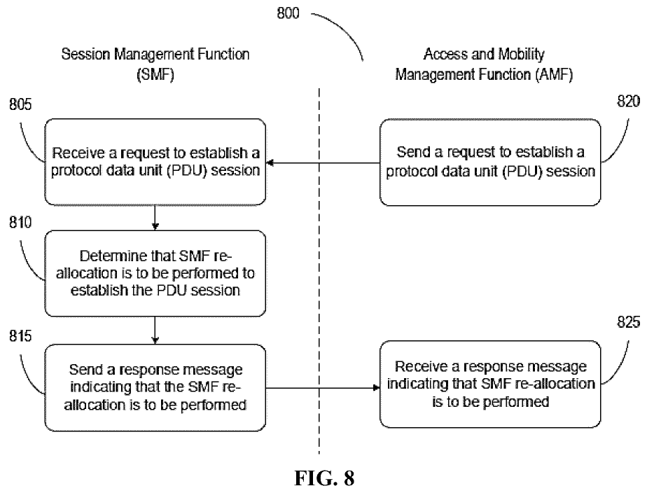

FIG. 8 illustrates a flow diagram of a method 800 for session management function (SMF) re-allocation. The method 800 may be implemented using any one or more of the components and devices detailed herein in conjunction with FIGS. 1-7. In overview, the method 800 may be performed by a wireless communication node, in some embodiments. Additional, fewer, or different operations may be performed in the method 800 depending on the embodiment. At least one aspect of the operations is directed to a system, method, apparatus, or a computer-readable medium.

A session management function (SMF) may receive a request to establish a protocol data unit (PDU) session from an access and mobility management function (AMF). The SMF may determine that SMF re-allocation is to be performed to establish the PDU session. The SMF may send a response message indicating that the SMF re-allocation is to be performed to the AMF. The SMF may determine, according to information in the request from the AMF, that at least one of: the SMF cannot establish the PDU session, or the SMF re-allocation is to be performed to establish the PDU session. The SMF may determine, according to information, that at least one of: the SMF does not support at least one capability required by an application triggering establishment of the PDU session, one or more UPFs managed by the SMF do not support the at least one capability, the SMF is overloaded, or the one or more UPFs are overloaded.

In some embodiments, the SMF may send an request to a network slice selection function (NSSF), to request a network repository function (NRF) to be used to select one or more network functions or services. The SMF may receive an identification of the NRF from the NSSF. The NSSF may at least one of: select a network slice instance, determine the NRF to be used to identify at least one candidate SMF within the network slice instance, or send an identifier corresponding to the network slice instance, to the SMF. The SMF may send a request to the NRF to discover the at least one candidate SMF for the PDU session. The SMF may receive information about the at least one candidate SMF from the NRF.

In some embodiments, the SMF may select a target SMF from the at least one candidate SMF. The SMF may send a request (e.g., Nsmf_PDUSession_CreateSMContext Request) to the target SMF. The request may comprise at least one of: an identifier of the AMF, an identifier of the PDU session, an N1 session management (SM) container or PDU session establishment request, a subscription permanent identifier (SUPI), a selected data network name (DNN), a DNN requested by a user equipment (UE), at least one single-network slice selection assistance information (S-NSSAI), or a request type. The SMF may receive the response message (e.g., Nsmf_PDUSession_CreateSMContext Response) from the target SMF. The response message may comprise an identifier (ID) of a session management (SM) context created by the target SMF. The SMF may send the response message (e.g., Nsmf_PDUSession_CreateSMContext Response) to the AMF. The response message may include at least one of: an ID of the target SMF, the ID of the SM context, or an indication that the target SMF is to process the request. If the AMF receives the ID of the target SMF, the AMF may communicate with the target SMF to establish the PDU session.

In some embodiments, the SMF may send the response message (e.g., Nsmf_PDUSession_CreateSMContext Response) to the AMF if the SMF is unable to identify a target SMF. The message may include at least one of: an indication that the SMF is unable to process the request, an indication that the SMF re-allocation is to be performed, or a reason that the SMF is unable to process the request. The AMF may query a network repository function (NRF) to select an alternative SMF which supports one or more capabilities (capability to establish the PDU session) that the SMF lacks.

In some embodiments, an access and mobility management function (AMF) may send a request to establish a protocol data unit (PDU) session to a session management function (SMF). The AMF may receive a response message indicating that SMF re-allocation is to be performed, if the SMF determines that the SMF re-allocation is to be performed to establish the PDU session, from the SMF.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a session management function (SMF) from an access and mobility management function (AMF), a request to establish a protocol data unit (PDU) session;
determining, by the SMF, that SMF re-allocation is to be performed to establish the PDU session; and
sending, by the SMF to the AMF, a response message indicating that the SMF re-allocation is to be performed.

2. The method of claim 1, comprising:
determining, by the SMF according to information in the request from the AMF, that at least one of:
the SMF cannot establish the PDU session, or
the SMF re-allocation is to be performed to establish the PDU session.

3. The method of claim 2, comprising:
determining, by the SMF according to information, that at least one of:
the SMF does not support at least one capability required by an application triggering establishment of the PDU session,
one or more UPFs managed by the SMF do not support the at least one capability,
the SMF is overloaded, or
the one or more UPFs are overloaded.

4. The method of claim 1, comprising:
sending, by the SMF, an request to a network slice selection function (NSSF), to request a network repository function (NRF) to be used to select one or more network functions or services.

5. The method of claim 4, comprising:
receiving, by the SMF from the NSSF, an identification of the NRF, wherein the NSSF at least one of:
selects a network slice instance,
determines the NRF to be used to identify at least one candidate SMF within the network slice instance, or
sends an identifier corresponding to the network slice instance, to the SMF.

6. The method of claim 1, comprising:
sending, by the SMF, a request to the NRF to discover the at least one candidate SMF for the PDU session.

7. The method of claim 6, comprising:
receiving, by the SMF from the NRF, information about the at least one candidate SMF.

8. The method of claim 1- or 7, comprising:
selecting, by the SMF, a target SMF from the at least one candidate SMF; and
sending, by the SMF to the target SMF, a request comprising at least one of: an identifier of the AMF, an identifier of the PDU session, an N1 session management (SM) container or PDU session establishment request, a subscription permanent identifier (SUPI), a selected data network name (DNN), a DNN requested by a user equipment (UE), at least one single-network slice selection assistance information (S-NSSAI), or a request type.

9. The method of claim 1, comprising:
receiving, by the SMF from the target SMF, the response message, wherein the response message comprises an identifier (ID) of a session management (SM) context created by the target SMF.

10. The method of claim 7, comprising:
sending, by the SMF to the AMF, the response message, wherein the response message includes at least one of: an ID of the target SMF, the ID of the SM context, or an indication that the target SMF is to process the request.

11. The method of claim 10, wherein if the AMF receives the ID of the target SMF, the AMF communicates with the target SMF to establish the PDU session.

12. The method of claim 1, comprising:
sending, by the SMF to the AMF if the SMF is unable to identify a target SMF, the response message, wherein the response message includes at least one of:
an indication that the SMF is unable to process the request,
an indication that the SMF re-allocation is to be performed, or
a reason that the SMF is unable to process the request.

13. The method of claim 12, wherein the AMF queries a network repository function (NRF) to select an alternative SMF which supports one or more capabilities that the SMF lacks.

14. A method comprising:
sending, by an access and mobility management function (AMF) to a session management function (SMF), a request to establish a protocol data unit (PDU) session; and
receiving, by the AMF from the SMF, a response message indicating that SMF re-allocation is to be performed, if the SMF determines that the SMF re-allocation is to be performed to establish the PDU session.

15. A non-transitory computer readable medium storing instructions, which when executed by at least one processor, cause the at least one processor to perform the method of claim 1.

16. An apparatus comprising:
at least one processor configured to perform the following:
receiving, by a session management function (SMF) from an access and mobility management function (AMF), a request to establish a protocol data unit (PDU) session;
determining, by the SMF, that SMF re-allocation is to be performed to establish the PDU session; and
sending, by the SMF to the AMF, a response message indicating that the SMF re-allocation is to be performed.

17. The apparatus of claim 16, wherein the at least one processor is configured to perform:
determining, by the SMF according to information in the request from the AMF, that at least one of:
the SMF cannot establish the PDU session, or
the SMF re-allocation is to be performed to establish the PDU session.

18. The apparatus of claim 17, wherein the at least one processor is configured to perform:
determining, by the SMF according to information, that at least one of:
the SMF does not support at least one capability required by an application triggering establishment of the PDU session,
one or more UPFs managed by the SMF do not support the at least one capability,
the SMF is overloaded, or
the one or more UPFs are overloaded.

19. The apparatus of claim 16, wherein the at least one processor is configured to perform:
sending, by the SMF, an request to a network slice selection function (NSSF), to request a network repository function (NRF) to be used to select one or more network functions or services.

20. The apparatus of claim 19, wherein the at least one processor is configured to perform:
receiving, by the SMF from the NSSF, an identification of the NRF, wherein the NSSF at least one of:
selects a network slice instance,
determines the NRF to be used to identify at least one candidate SMF within the network slice instance, or
sends an identifier corresponding to the network slice instance, to the SMF.
